(19) United States
(12) Patent Application Publication
(10) Pub. No.: US 2015/0367901 A1
(43) Pub. Date: Dec. 24, 2015

(54) VEHICLE

(71) Applicant: Eugen STUDER, Höfen b. Thun (CH)

(72) Inventor: Eugen Studer, Höfen b. Thun (CH)

(21) Appl. No.: 14/764,788

(22) PCT Filed: Jan. 17, 2014
(86) PCT No.: PCT/EP2014/050933

§ 371 Date: Jul. 30, 2015

(30) Foreign Application Priority Data
Feb. 5, 2013 (CH) 403/13

(51) Int. Cl. B62D 55/084; B62D 55/116; B62D 55/075

(52) U.S. Cl. CPC B62D 55/084; B62D 55/075; B62D 55/116

(57) ABSTRACT

A vehicle comprises a chassis, on which at least one primary drive, working devices and control units can be arranged in a known manner, and at least two running gears fastened opposite each other laterally on the chassis and aligned parallel to one another. Each running gear has a carrier on which running elements are attached. There is at least one drivable drive unit per running gear by means of which at least one running element is drivable. One end region of a pivot lever is fastened on the chassis in a swiveling manner around a first shaft for each running gear. The other end region is linked on the carrier in a swiveling manner around a second shaft. A first actuator is attached between the chassis and the pivot lever and a second actuator is attached between the pivot lever and carrier via which the running gears can be moved to the widest range of positions.

The invention relates to a vehicle comprising a chassis, on which at least one primary drive, working devices and control units are disposed, and at least two running gears fastened opposite each other laterally on the chassis and aligned parallel to each other, which each have a carrier on which running elements are attached for driving the vehicle, at least one drivable drive unit being provided per running gear with which at least one running element is drivable.

Vehicles of this kind are used in diverse ways for carrying out work in open country. They can move also in relatively rough terrain. The most diverse working devices can be installed on the chassis of vehicles of this kind as superstructural parts. For example, such a working device could be a drilling device with which exploratory drillings can be carried out and with which soil samples can be taken. For this purpose, driven by the drive units, via which the running elements are able to be driven, the vehicle drives to the corresponding place where the work has to be carried out.

Work of this kind also has to be done on slopes, for example. Depending upon the inclination of the slope, it is not very easy for the vehicle to reach its site of operation since, starting with a certain inclination, there is a risk of tipping over of the vehicle. Moreover, for example, the drilling device has to be aligned perpendicular even in the respective hillside situation, which has to be achieved, for example, with additional devices, for instance extendable and height-adjustable support elements. Another possibility consists in equipping the drilling device with devices for adjustment with respect to the chassis, by means of which the drilling device can be adjusted in relation to the chassis in such a way that it is aligned perpendicular.

Such additional technical devices are costly and complicated to operate.

The object of the present invention is to create a vehicle in which the chassis can be held in, or respectively brought into, a substantially horizontal position.

This object is achieved according to the invention in that on the chassis, for each running gear, the one end region of a pivot lever is attached in a way pivotable about a first shaft, whose other end region is linked on the carrier of the running gear in a way pivotable about a second shaft, and in that attached between chassis and pivot lever is a first actuator and between pivot lever and carrier is a second actuator.

With this design the chassis of the vehicle can be brought into a substantially horizontal position. With lateral inclination, the one pivot lever with the one running gear is extended while the other pivot lever remains in the retracted position, whereby a lateral tilt can be compensated. The running gears can also be pivoted with respect to the pivot lever, whereby uphill or downhill gradients in the terrain can be compensated and also in this case the chassis can be held in the substantially horizontally aligned position. Of course a combined adjustment of the running gears is also possible. In this way the caterpillar-type vehicle can easily move in rough terrain. The risk of tipping over is reduced dramatically. Moreover the working device can be brought in an optimal way into the correct position with respect to the terrain.

The first axes and the second axes are preferably aligned parallel to one another and transversely to the driving direction of the vehicle, which enables an easy movement of the vehicle and a simple adjustment of the chassis.

The actuators are preferably designed as hydraulic cylinders since, especially with vehicles having a drilling device placed on them, a hydraulic system is provided anyway. A simple structure thereby results.

The first actuators and the second actuators are preferably adjustable individually and independently of one another, whereby an optimal alignment of the chassis results.

Another advantageous embodiment of the invention consists in that attached to each of the second axes is a pivot mechanism, by means of which the respective running gear is pivotable about a third shaft, which is aligned transversely to the second shaft. The bearing surface of each running gear with respect to the corresponding inclination of the terrain surface can be aligned transversely to the driving direction, whereby additional stability of the vehicle is achievable.

For pivoting of the running gears with respect to the respective second shaft, a hydraulic drive is preferably provided in each case, which results in a simple construction for the pivot mechanism.

The drive unit for driving the running elements is preferably designed as hydraulic motor. Here too, owing to the presence of a hydraulic system on the vehicle, a simple construction results in a corresponding way.

A further advantageous embodiment of the invention consists in that installed on the chassis is a sensor, with which the inclination of the chassis with respect to the horizontal position is detectable, and in that a control device is provided with which the actuators are controllable in such a way that the chassis is able to be kept substantially in the horizontal position. This automatic alignment of the chassis facilitates the operation and locomotion of the vehicle in the terrain.

An embodiment of the invention will be explained more closely in the following, by way of example, with reference to the attached drawings, this embodiment being a vehicle in which the running elements of the running gears are designed as caterpillar tracks or continuous treads.

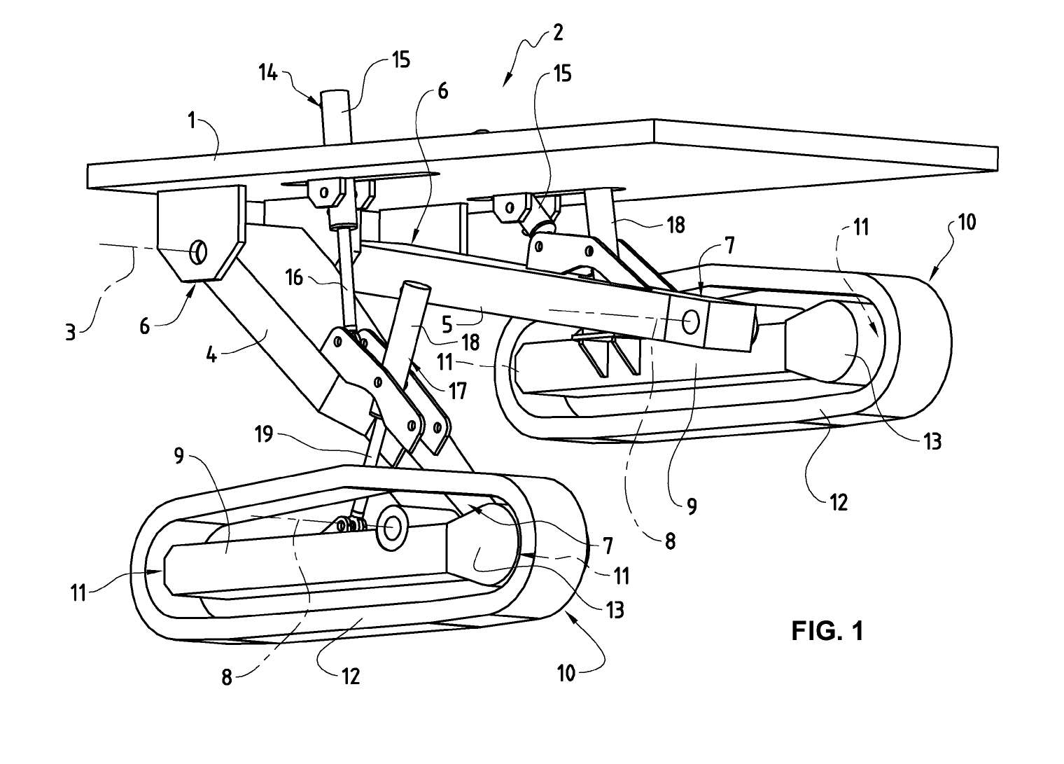

FIG. 1 shows diagrammatically the chassis and the running gears, disposed thereon and equipped with caterpillar tracks, of a vehicle in a spatial or 3D representation, the one running gear being in raised state and the other running gear in lowered state;

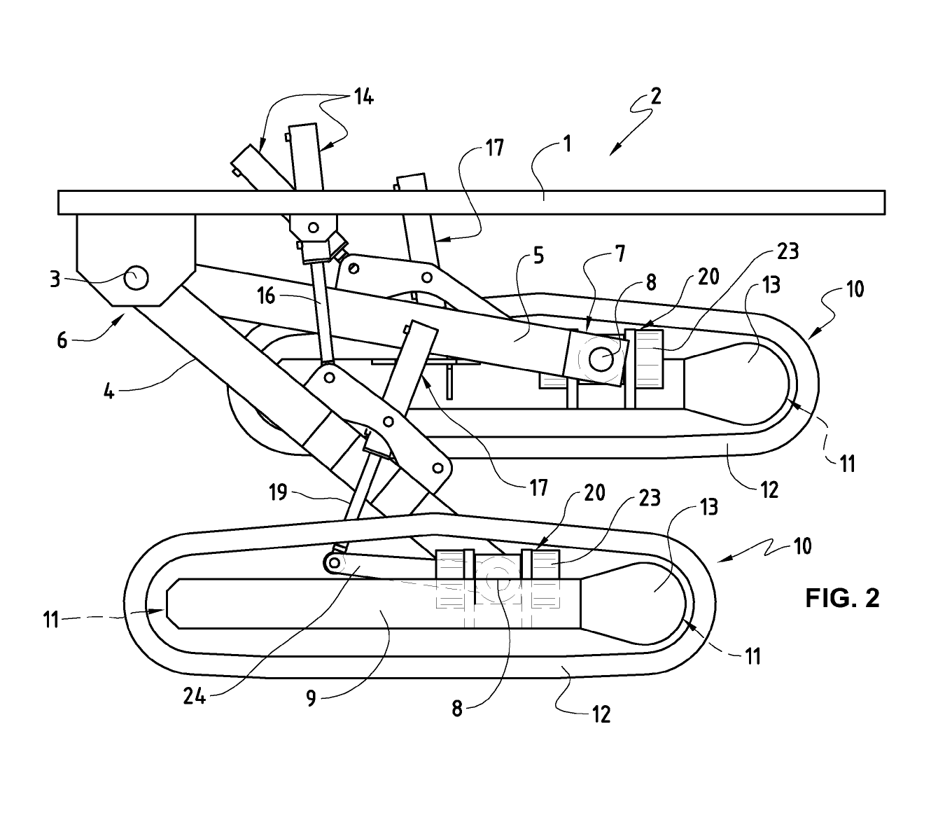

FIG. 2 shows in a diagrammatic representation a lateral view of the vehicle according to FIG. 1, with additional pivot mechanism for the running gears;

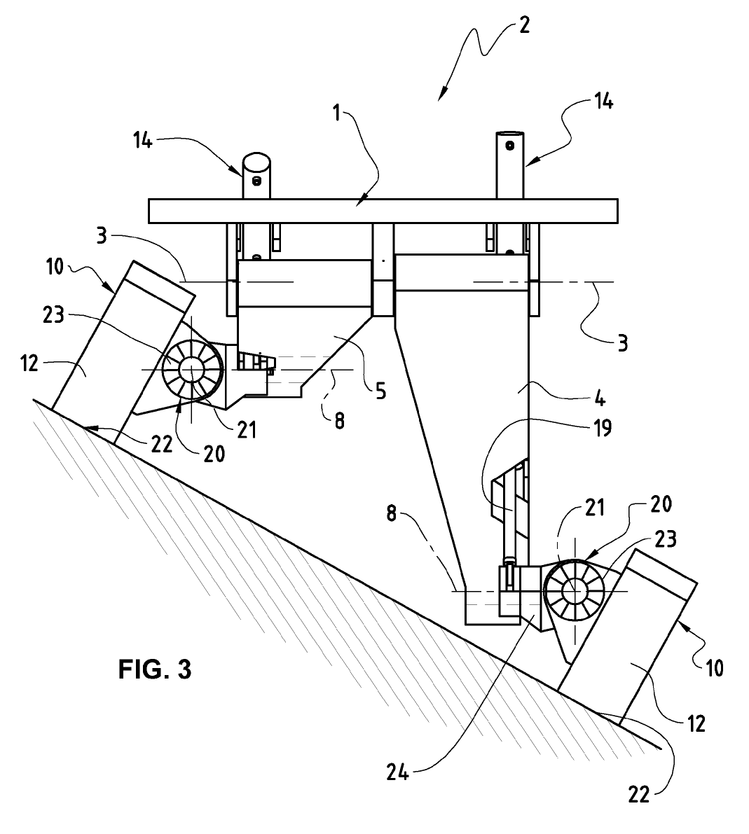

FIG. 3 shows in a diagrammatic representation a view from the front of the vehicle according to FIG. 2; and

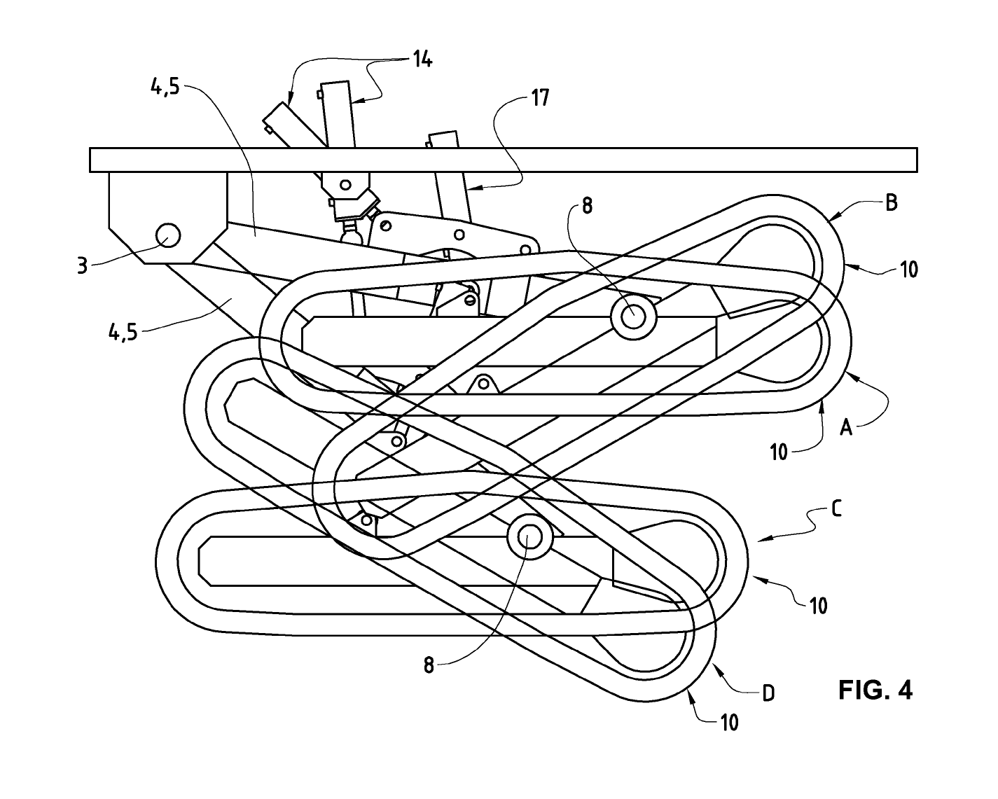

FIG. 4 shows in a diagrammatic representation a lateral view of the vehicle according to FIG. 1, the various positions of the running gears being illustrated.

Visible from FIGS. 1 and 2 is the chassis 1 of the vehicle 2, shown very schematically and in a simplified way. In a known way (not shown), the units necessary for the operation of such a vehicle, such as a primary drive, working devices and control units, are installed on the chassis. For example a drilling device can be placed on a vehicle 2 of this kind, with which drilling device exploratory drillings in the terrain can be carried out in a known way and with which soil samples can be taken. A diesel motor serves, for example, as the primary drive, with which a hydraulic pump of a hydraulic system can be driven.

Firmly attached on the chassis 1 is a first shaft 3. Two adjacently disposed pivot levers 4, 5 are pivotable about this first shaft 3, in each case the one end region 6 of these pivot levers 4 and 5 being provided in a known way with corresponding bearings. Installed on the other end region 7 in each case of the two pivot levers 4 and 5 is a second shaft 8, about which a carrier 9 in each case of a running gear 10 is pivotably borne. In the embodiment example illustrated here, the running elements 12 are designed as continuous tracks or continuous treads, which will be referred to in the following and in the figures as caterpillar tracks and will be provided in each case with the reference numeral 12. The carrier 9 is provided for this purpose in a known way (not shown) with a switching element 11 at the respective end regions, which element is designed as a wheel, for example, on which switching elements an endless caterpillar track 12 is placed. These two caterpillar tracks 12 can be driven, for example, via hydraulic motors 13 installed on the carrier 9.

Disposed between the chassis 1 and the respective pivot lever 4, 5 is in each case a first actuator 14, which is designed as hydraulic cylinder 15. Through extension of the piston rod 16 of the hydraulic cylinder 15 the pivot lever 4 can be brought into the extended position, as can be seen in FIG. 1 on the left side. With retraction of the piston rod 16 of the hydraulic cylinder 15 for the pivot lever 5, the pivot lever 5 can be brought into the raised position, as shown in FIG. 1 on the right side.

Inserted between the respective carrier 9 and the corresponding pivot lever 4 or respectively 5 is a second actuator 17, which is likewise designed as hydraulic cylinder 18. Through extension of the piston rod 19 of the hydraulic cylinder 18, the carrier 9 and thus the running gear 10 can be pivoted open with respect to the pivot lever 4, as is shown in FIG. 1 on the left side. With retraction of the piston rod 19 of the hydraulic cylinder 18, the carrier 9 and consequently the running gear 10 are swung closed with respect to the pivot lever 5, as is shown in FIG. 1 on the right side.

As can be seen from FIG. 3, through these adjustment possibilities of the running gears 10, the vehicle 2 can be driven transversely to inclined slopes. The running gear 10 situated upward on the slope is brought into the retracted position via the raising of the pivot lever 5. The running gear 10 situated downwards on the slope is brought into the extended position via the swung-out pivot lever 4. The chassis 1 of the vehicle 2 can thereby be kept in a relatively horizontal position.

It can be seen from FIG. 2 and FIG. 3 that in each case a pivot mechanism 20 can be inserted between the second shaft 8 and the corresponding running gear 10. This pivot mechanism 20 makes it possible for each running gear 10 to be pivotable with respect to the second shaft 8, and, to be more precise, about a third shaft 21, which is aligned transversely to the second shaft 8. As can be seen in particular from FIG. 3, this pivotability of the running gears 10 enables the bearing surfaces 22 of the running elements, for example the caterpillar tracks 12, to be alignable with respect to the inclination of the terrain surface transversely to the driving direction of the vehicle, so that the bearing surfaces 22 are able to lie flat on the terrain surface and the stability of the vehicle in the terrain is improved. The pivoting of the running gears 10 can be achieved through one hydraulic motor 23 each. Of course other suitable adjustment mechanisms are also conceivable.

As can be seen in particular from FIG. 2, when the above-described pivot mechanisms 20 are installed on the vehicle, a pivot lever 24 can be attached on the second shaft 8, <and> also the running gear 10 is attached to the second shaft 8, the second shaft 8 is rotatably borne in the pivot lever 4 or respectively in the pivot lever 5. The piston rod 19 of the hydraulic cylinder 18 of the second actuator 17 is linked to the pivot lever 24.

Visible from FIG. 4 are different positions of the running gears 10.

The position A shows the running gear 10 with the raised position of the pivot lever 4 or respectively 5. This means that the first actuator 14 is in the retracted position. The second actuator 17 is likewise in the retracted position. In this position A the running gear 10 is aligned substantially parallel to the chassis 1.

The position B shows the running gear 10 also with the raised pivot lever 4 or respectively 5. However the second actuator 17 is in the extended position. The running gear 10 is thus in an inclined position with respect to the chassis 1. When both running gears 10 are in this position, the vehicle 2 can move upwards on the slope or downwards on the slope, for example. The chassis 1 is situated here too in a substantially horizontal position, however.

In order to bring the running gear 10 into the position C, the respective pivot lever 4 or respectively 5 is brought into the downward pivoted position via the first actuator 14. The second actuator 17 is brought into a driven-out position, so that the running gear 10 is situated in substantially parallel alignment with respect to the chassis 1, but has a greater spacing apart from the chassis, in contrast to position A. In the pivoted open position of the pivot lever 4 or respectively 5, the second actuator 17 can be brought into the retracted position. The running gear 10 then reaches position D. Also in this position the vehicle 2 can drive upwards on the slope or downwards on the slope, for example, whereby the chassis 1 is situated substantially in a horizontal position.

Through these adjustment possibilities for the two running gears 10 of a vehicle 2, hillsides in the terrain can be overcome or inclined slopes traversed. Through corresponding adjustment of the respective running gears 10, the chassis 1 can be always kept practically in the horizontal position whereby the risk of tipping over of the vehicle can be dramatically reduced.

Of course it would be conceivable for a known sensor (not shown) to be installed on the chassis 1, with which sensor the inclination of the chassis 1 with respect to the horizontal position is detectable, and for a control device to be provided in a known way (not shown), which can be disposed on the chassis, with which control device the actuators 14 and 17 are controllable in such a way that the chassis 1 is able to be maintained substantially in the horizontal position, even when the vehicle moves in changing terrain.

When the vehicle 2 has reached the desired spot, the chassis can be aligned in the desired position through corresponding adjustment of the running gears 10, so that a correct drilling procedure can be carried out, for example.

In the embodiment example described in the foregoing, the running elements 12 are designed as caterpillar tracks. Of course it is also conceivable for the running elements 12 to be designed differently, for example as wheels. The wheels can thereby be installed on the respective running gear in a known way, it being possible to provide for a multiplicity of wheels per running gear which wheels can also be steerable. Tire-wheels can be used as wheels. Of course other suitable wheels are also usable.

By equipping a vehicle in this way according to the invention this vehicle can be made to be very all-terrain. In particular it thereby becomes also possible to align the chassis in the correct position before the operating procedure to be carried out.

1. Vehicle, comprising a chassis, on which are disposed at least one primary drive, working devices and control units, and at least two running gears fastened opposite each other laterally on the chassis and aligned parallel to one another, which each have a carrier, on which are attached running elements for driving the vehicle, at least one drivable drive unit being provided per said running gear, with which at least one said running element is drivable, wherein on the chassis, for each said running gear, one end region of a pivot lever is attached in a way pivotable about a first shaft, whose other end region is linked on the carrier in a way pivotable about a second shaft, in that attached between said chassis and said pivot lever is a first actuator and between said pivot lever and said carrier is a second actuator.

2. Vehicle according to claim 1, wherein the first shafts and the second shafts are aligned parallel to one another and transversely to the driving direction of the vehicle.

3. Vehicle according to claim 1, the wherein said first actuator and said second actuator are designed as hydraulic cylinders.

4. Vehicle according to claim 1, wherein said first actuators and said second actuators are adjustable individually and independently of one another.

5. Vehicle according to claim 1, wherein attached to each of the second shafts is a pivot mechanism, by means of which the respective running gear is pivotable about a third shaft, which is aligned transversely to the second shaft.

6. Vehicle according to claim 5, wherein for pivoting of the running gears with respect to the respective second shaft a hydraulic drive is provided in each case.

7. Vehicle according to claim 1, wherein the drive unit for driving said at least one running element is designed as hydraulic motor.

8. Vehicle according to claim 1, wherein installed on the chassis is a sensor, with which the inclination of the chassis with respect to the horizontal position is detectable, and in that a control device is provided with which said first actuator and said second actuator are controllable in such a way that the chassis is able to be kept substantially in the horizontal position.
